(19) United States
(12) Patent Application Publication
(10) Pub. No.: US 2010/0149163 A1
(43) Pub. Date: Jun. 17, 2010

(54) USE OF SPATIAL HIGH-PASS FILTERING OF IMAGES TO INCREASE PERCEIVED BRIGHTNESS OF EMISSIVE DISPLAY

(75) Inventor: Jonathan Betts-LaCroix, San Francicso, CA (US)

Correspondence Address: Mattingly & Malur, P.C., Suite 370, 1800 Diagonal Road, Alexandria, VA, 22314, US

(73) Assignee: OQO, INC., San Francisco, CA (US)

(21) Appl. No.: 12/538,841

(22) Filed: Aug. 10, 2009

Related U.S. Application Data
(60) Provisional application No. 61/087,629, filed on Aug. 8, 2008.

(51) Int. Cl. G09G 5/00

(52) U.S. Cl. 345/212

(57) ABSTRACT

A method enables power savings in an OLED display by shortening the duty cycle of selected OLEDs of the OLED display. The selected OLEDs may include, for example, OLEDs used to generate particular objects that appear to be inactive such as inactive windows. Shortening the duty cycles of the selected OLEDs results in overall power savings when operating the OLED display.

This application claims priority from U.S. Provisional Patent Application Ser. No. 61/087,629, entitled USE OF SPATIAL HIGH-PASS FILTERING OF IMAGES TO INCREASE PERCEIVED BRIGHTNESS OF EMISSIVE DISPLAY, filed on Aug. 8, 2008, which is hereby incorporated by reference as if set forth in full in this application for all purposes.

### BACKGROUND

An organic light-emitting diode (OLED) is a light-emitting diode having an emissive electroluminescent layer containing organic compounds. In an OLED display, OLEDs function as picture elements or pixels arranged in a two-dimensional grid or array, where each pixel represents a portion a displayed image. OLED technology is used in display systems such as computer displays, personal digital assistant (PDA) screens, television screens, etc. Unlike liquid crystal displays (LCDs), OLED displays do not require a backlight to function and thus consume far less power than LCDs. However, continual improvements in power efficiency remains desirable, especially as portable computing devices become smaller.

### SUMMARY OF EMBODIMENTS OF THE INVENTION

A method enables power savings in an OLED display by shortening the duty cycle of selected OLEDs of the OLED display. The selected OLEDs may include, for example, OLEDs used to generate particular images that appear to be inactive such as inactive windows. Shortening the duty cycles of the selected OLEDs results in overall power savings when operating the OLED display.

In one embodiment the invention provides a method for implementing a display, the method comprising: selecting a plurality of light-emitting elements in a display based; and adjusting a duty cycle of each of the selected light-emitting elements.

### BRIEF DESCRIPTION OF THE DRAWINGS

FIG. 1 is an example schematic diagram of an OLED array used in an OLED display.

FIG. 2A illustrates an example waveform showing a 50% duty cycle of an OLED.

FIG. 2B illustrates an example waveform showing a 33% duty cycle of an OLED.

### DETAILED DESCRIPTION OF THE INVENTION

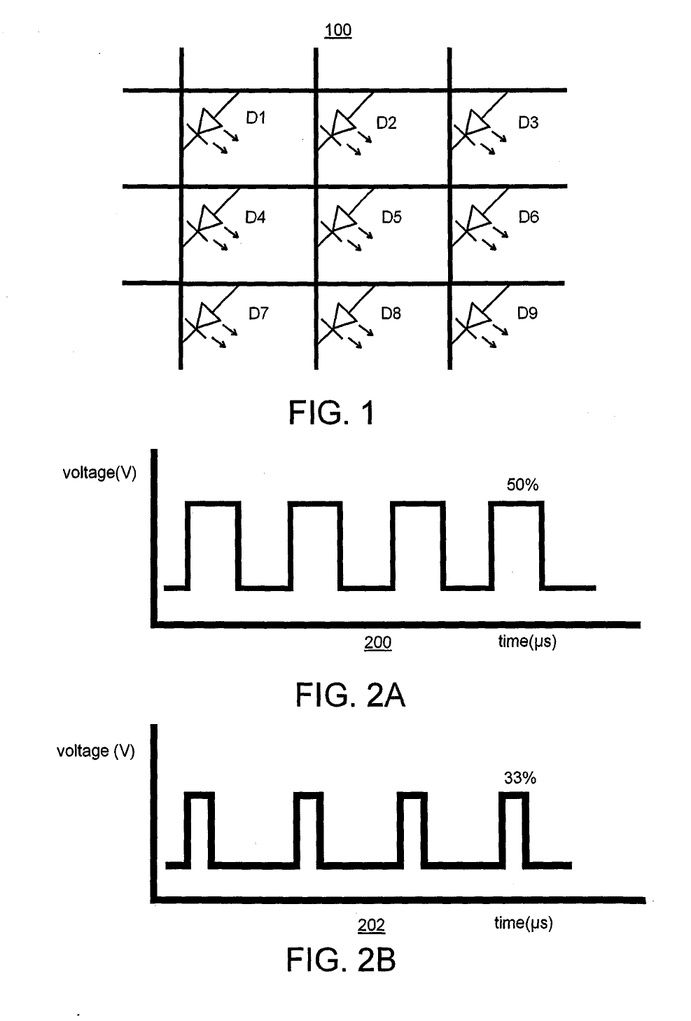

FIG. 1 is an example schematic diagram of an OLED array 100 used in an OLED display. In FIG. 1, OLED array 100 includes a two-dimensional array of OLEDs D1-D9. In a given application, OLEDs D1-D9 function as picture elements or pixels, where each pixel represents a portion of a displayed image or object. Although only a 3×3 array is shown for simplicity, embodiments described herein may be applied to arrays of larger sizes (e.g., 800×600, 1280×720, etc.). OLED array 100 may be used in OLED displays of any type of computing device such as a personal computer, laptop, ultra-portable computer, cell phone, audio player, navigation or location system, or any other device.

The power consumption of each of the OLEDs D1-D9 may be controlled (e.g., lowered, raised, or maintained) individually by controlling the percentage of the time that a given OLED is on (referred to as a duty cycle). For example, if the pulse duration of the OLED is 500 microseconds and the pulse period is 1,000 microseconds, the duty cycle would be 0.5, or 50%. If the pulse duration is 333 microseconds and the pulse period is 1,000 microseconds, the duty cycle would be 0.33, or 33%.

As described in more detail below, the duty cycle may be adjusted such that the pulse width for selected OLEDs is shortened in order to reduce power consumption. A software application stored in a memory or computer-readable storage medium provides instructions that enable a processor to perform this function and other functions described herein.

In one embodiment, the software application selects OLEDs in the OLED display. For example, in one embodiment, the software application may select all of the OLEDs in the OLED display. The software application then adjusts the duty cycle of each of the selected OLEDs (also referred to as pulse-width modulation). More specifically, in one embodiment, the software application reduces the duty cycle of each of the OLEDs to a predefined threshold. FIG. 2A illustrates an example waveform showing a 50% duty cycle of a given selected OLED. As

FIG. 2A shows, the OLED is on 50% of the time. FIG. 2B illustrates an example waveform showing a 33% duty cycle of same OLED. As FIG. 2A shows, the OLED is on 33% of the time. In particular embodiments, if the software application reduces the duty cycle of the OLED from a 50% duty cycle to a 33% duty cycle, the power consumption for the OLED would be reduced. This results in substantial power savings in the overall OLED display when the duty cycle of all of the OLEDs is shortened.

The human eye is slow to integrated fast changes in the luminance of the OLEDs. As such, when the duty cycle of a given OLED and even all of the OLEDs is reduced to a predefined threshold (e.g., from 50% to 33%), the human eye will not notice the difference, because the human is slow to integrate such a short absence of luminosity. In particular embodiments, the software application-may compress the time scale of the pulse-width modulation such that the duty cycle uses less time, but is within the integration time of the eye. In one embodiment, the software application may average or edge enhance the methods described herein to affect what the human eye perceives as bright.

In one embodiment, the software application selects OLEDs in an OLED display based on the usage of the OLEDs. In one embodiment, the software application selects OLEDs that produces images or objects that do not appear to be active. For example, the software application may select OLEDs used to generate windows that are not currently active. In this example, when the user uses a mouse to click on a particular window, making that window active, the software application may then select the OLEDs outside of the active window. In other words, the software application selects all of the OLEDs that do not generate the active window image. The software application then adjusts the duty cycle of each of the selected OLEDs.

In particular embodiments, a reduction in duty cycle below a given threshold (e.g., 33%) may result in a dimming effect, where the human eye notices the change in duty cycle. Conversely, an increase in duty cycle above a given threshold (e.g., 75%) may result in a brightening effect, where the human eye notices the change in duty cycle. In other words, embodiments may use pulse-width modulation to modulate the brightness or luminosity of pixels. As such, in one embodiment, the software application may select some OLEDs for a more substantial decrease in duty cycle and thus a more substantial reduction of power consumption. Such OLEDs may be those that appear to be generating inactive objects such as inactive windows. Conversely, the software application make also select some OLEDs for a more substantial increase in duty cycle and thus increase the perceived brightness of particular displayed objects. Such OLEDs may be those that appear to be generating active objects such as active windows. While the power consumption increases for these OLEDs, the increase is offset by the decrease in power consumption of the OLEDs experiences a reduction in duty cycle. In one embodiment, the software application may perform the selective adjustments in duty cycle in order to achieve a substantial net decrease in power consumption. This achieves the benefit reducing power consumption while enhancing the user experience, as the dimmed portions of the display are inactive anyway, and the active portions of the display appear brighter to the user.

In other embodiments, the software application may select OLEDs based on a variety of criteria. For example, the software application may select OLEDs based on spatial frequency contrast (e.g., all OLEDs except those around textured regions of the display). In one embodiment, the software application may determine the luminance of the each of the OLEDs, compare luminance values of the OLEDs, and identify OLEDs in regions of the display having greater contrast. In one embodiment, the software application may deem these regions of contrast as borders of images and may select OLEDS other than those in these regions to more substantially decrease the duty cycle. This would reduce overall power consumption while preserving sufficient brightness in select regions.

In one embodiment, the software application that may select particular OLEDs that generate certain colors or a certain range of colors. For example, the software application may dim OLEDs that produce white, off-white, or light colors, etc. In particular applications such as email applications, where there is black text over a white background, it is not critical that the white background be bright. As such, the software application may select the corresponding OLEDS for duty cycle reduction. Even thought there may be some perceived dimming, the dimming is nominal while the power savings is great.

The embodiments described herein result in lower power consumption in OLED systems, while not reducing the visibility of particular displayed objects or otherwise compromising the user experience. Some embodiments achieve lower power consumption in OLED systems, while increasing the perceived brightness of particular displayed objects. The lower power consumption is especially beneficial in mobile device applications where improved battery life is highly valued. Furthermore, these embodiments increase the lifespan of OLEDs and OLED displays in general due to the overall decreased usage of the OLEDs.

In particular embodiments, it is possible to achieve the same perceived intensity output or luminance of an OLED display as a prior art display (e.g., LCD displays, etc.) even when the OLEDs of the OLED display are operating with a lower duty cycle than that of the LEDs of the prior art display. For example, if the duty cycle of the LEDs of an LCD display that consumes 100 watts is reduced to 50%, the LCD display will then consume 50 watts, which is a power reduction of 50%. If the duty cycle of the OLEDs of an OLED display that consumes 100 watts is reduced to 33%, the OLED display will then consume 33 watts, which is a power reduction of 67%, a greater power reduction than that of the LCD display. However, the perceived luminance of both the OLED display and LCD display will be the same.

Although specific embodiments of the invention have been described, variations of such embodiments are possible and are within the scope of the invention.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A method for implementing a display, the method comprising:
selecting a plurality of light-emitting elements in a display; and
adjusting a duty cycle of each of the selected light-emitting elements.
